(19) United States
(12) Patent Application Publication
(10) Pub. No.: US 2011/0184539 A1
(43) Pub. Date: Jul. 28, 2011

(54) SELECTING AUDIO DATA TO BE PLAYED BACK IN AN AUDIO REPRODUCTION DEVICE

(75) Inventors: Markus Agevik, Malmo (SE); David Johansson, Limhamn (SE); Andreas Münchmeyer, Rydeback (SE)

(73) Assignee: SONY ERICSSON MOBILE COMMUNICATIONS AB, Lund (SE)

(21) Appl. No.: 12/692,211

(22) Filed: Jan. 22, 2010

(51) Int. Cl. G06F 17/00

(52) U.S. Cl. 700/94

(57) ABSTRACT

A method for selecting audio data to be played back in an audio reproduction device, and an audio reproduction device are described.

### BACKGROUND OF THE INVENTION

The present invention relates to a method for selecting audio data to be played back in an audio reproduction device, and an audio reproduction device utilizing the method for selecting audio data.

### BRIEF SUMMARY OF THE INVENTION

According to an embodiment, a method for selecting audio data to be played back in an audio reproduction device is provided. According to the method, an ambient information of an ambience of the audio reproduction device is automatically determined, i.e. the ambient information of an area surrounding the audio reproduction device is automatically determined. Furthermore, audio data to be played back is automatically selected from a plurality of audio data depending on the determined ambient information.

The audio reproduction device may be a mobile device, for example a mobile phone, a personal digital assistant, a mobile navigation system, a mobile music player, a mobile computer, or a stationary device, for example an amplifier, an internet radio, or a DLNA (digital living network alliance) playback device.

A large variety of audio reproduction devices, especially the above-mentioned mobile devices like mobile phones or MP3 players, are currently available and adapted to play back music from a large variety of music titles. Therefore, these audio reproduction devices are usable for entertaining a larger group of people at a party, a festival or the like. Although these audio reproduction devices typically provide so-called play lists containing several audio files to be played back, for adapting the currently played music to a current situation or mood of the party, typically a person acting as a disc jockey is needed. To avoid the necessity of providing a person acting as a disc jockey, according to the above-defined embodiment of the present invention, an ambient information, is determined and audio data to be played back is automatically selected depending on the determined ambient information.

According to an embodiment, the ambient information comprises an ambient background noise level of the ambience surrounding the audio reproduction device. As the ambient background noise level arises during a party, this is an appropriate indicator indicating the current mood or level of the party.

According to an embodiment, the ambient background noise level is determined by capturing ambient audio data of the audio reproduction device, and by removing audio data currently played back by the audio reproduction device from the captured ambient audio data. Thus, the ambient background noise level can be determined accurately independent from the currently played back audio data.

According to a further embodiment, the ambient information may comprise for example a movement information of a user carrying the audio reproduction device, a movement information concerning objects in an ambience of the audio reproduction device, an ambient illumination information, a weight sensor information, a smoke sensor information, a gas sensor information, an information about an ambient alcohol concentration of the audio reproduction device, a temperature information of the ambient temperature of the audio reproduction device and/or a voice characteristic information in the ambient background noise.

A movement information of a user carrying the audio reproduction device may be determined by an acceleration sensor of the audio reproduction device. When the audio reproduction device is a mobile device and carried around by the user and the music of the audio reproduction device is transferred via a radio frequency connection, for example WLAN or Bluetooth, to a corresponding amplifier station, the movement information may indicate a movement or dancing intensity of the user which may be used to determine a current mood and therefore audio data to be played back. Furthermore, the audio reproduction device may provide a camera to determine a movement information about objects in an ambience of the audio reproduction device. Thus, the audio reproduction device may determine a mood from the movement of the people in the ambience of the audio reproduction device.

An ambient illumination information, for example determined by a camera of the audio reproduction device, may be further used to determine the mood and audio data to be played back.

The audio reproduction device may be adapted to determine a weight information, for example by an external weight sensor which may be installed for example under a popcorn bowl or under a beer barrel. The further the party progresses, the lighter the weight of the popcorn bowl or the beer barrel becomes. From this information, a mood of the party may be determined. Furthermore, the audio reproduction device may be coupled with or may provide a gas sensor to provide a gas sensor information indicating for example an ambient alcohol concentration, a carbon dioxide concentration or a carbon monoxide concentration. The higher the gas concentrations are, the further the party has progressed and the audio data to be played back can be adapted accordingly.

An temperature information, for example determined by a temperature sensor of the audio reproduction device indicating for example a room temperature, may be further used to determine the mood and audio data to be played back.

Finally, a voice characteristic information in the ambient background noise may be determined indicating if there are more male persons present having a deep voice or more female persons having a high voice. Depending on this, audio data preferably heard by men or preferably heard by women may be selected.

According to another embodiment, a plurality of mood categories is provided and each of the plurality of audio data is assigned to at least one of the plurality of mood categories. Furthermore, ambient information ranges are defined and assigned to each of the plurality of mood categories. Based on the determined ambient information, one of the mood categories is selected and audio data assigned to the selected mood category is automatically selected as the audio data to be played back. By defining several mood categories or levels, for example one level for a party initialization phase at the early evening, another one for an ascending phase of the mood of the party, a next one for the party peak, and another one for a late evening phase of the party, an implementation for selecting audio data may be simplified.

Each of the plurality of audio data may be assigned to at least one of the plurality of mood categories based on a speed of a beat of the audio data. Furthermore, audio data may be assigned based on a genre of the audio data to at least one of the plurality of mood categories. In addition, the audio data may be assigned to at least one of the plurality of mood categories based on an amount of major or minor scales.

Each mood category may comprise a volume offset level to adjust the volume of the audio data of the mood category, when audio data of the mood category is played back. Thus, the volume level can be adjusted relative to a starting point volume level.

According to another embodiment, a first input from a user specifying a mood category is captured and audio data identifiers of the audio data assigned to the specified mood category is output to the user. A second input from the user selecting at least one of the audio data identifiers is captured and the audio data identified by the selected audio data identifier is played back. Thus, a user is able to initialize the playback of the audio data taking into account the current mood of the party. Furthermore, the audio data selected by the user indicates the kind of music the user prefers which may be considered by the automatic selection of further audio data afterwards.

The audio data may comprise an audio file containing audible music when being played back or the audio data may comprise a list of audio files containing audible music when being played back.

According to an embodiment, a method for selecting audio data to be played back in an audio reproduction device is provided. According to the method, a time information is determined, and audio data to be played back is automatically selected from a plurality of audio data depending on the determined time information.

The time information may comprise a time of day information or a day of week information.

The time of day information may be used to heat up the party until a predetermined time of day, for example one or two o'clock in the morning, and to cool down the party afterwards. Furthermore, the day of the week information, for example Friday, Saturday, Sunday and so on, may be used to adjust the selected music additionally taking into account, that for example an after-work party on Monday till Thursday may use another time schedule than a party on Friday or Saturday.

According to another embodiment of the present invention, an audio reproduction device comprising a processing unit having access to a plurality of audio data is provided. The processing unit is adapted to determine an ambient information of an ambience surrounding the audio reproduction device, and to select automatically audio data to be played back from the plurality of audio data depending on the determined ambient information.

According to another embodiment of the present invention, an audio reproduction device comprising a processing unit having access to a plurality of audio data is provided. The processing unit is adapted to determine a time information, and to select automatically audio data to be played back from the plurality of audio data depending on the determined time information.

The audio reproduction device may comprise a mobile device. Furthermore, the audio reproduction device may comprise a mobile phone, a personal digital assistant, a mobile navigation system, a mobile music player or a mobile computer. The audio reproduction device may also comprise a stationary device or a split device comprising for example a separate wireless microphone, a wireless playback device and a mobile or stationary amplification device.

Although specific features described in the above summary and the following detailed description are described in connection with specific embodiments, it is to be understood that the features of the embodiments described can be combined with each other unless it is noted otherwise.

### BRIEF DESCRIPTION OF THE DRAWINGS

Hereinafter, exemplary embodiments of the invention will be described with reference to the drawings.

FIG. 1 shows a mobile device according to an embodiment of the present invention.

FIG. 2 shows method steps of a method for selecting audio data to be played back in an audio reproduction device according to an embodiment of the present invention.

FIG. 3 shows the step of creating a playlist of FIG. 2 in more detail.

### DETAILED DESCRIPTION OF THE INVENTION

In the following, exemplary embodiments of the present invention will be described in detail. It is to be understood that the following description is given only for the purpose of illustrating the principles of the invention and it is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise.

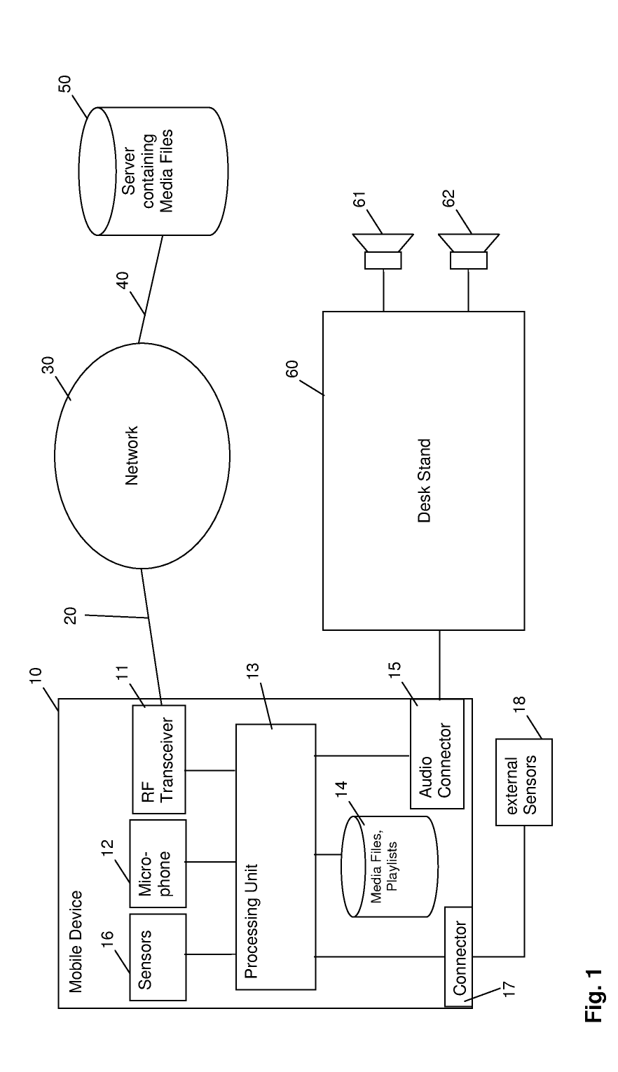

FIG. 1 shows schematically a mobile device 10 which may be connected to a server 50 via a network 30. A connection 20 between the mobile device 10 and the network 30 may be a wireless connection, for example a GSM, a UMTS, GPRS or Bluetooth connection. However, connection 20 may be any other kind of wireless or wired connection. Connection 40 between the network 30 and the server 50 may be also any kind of wireless or wired connection.

The mobile device 10 comprises a radio frequency transceiver 11, a microphone 12, a processing unit 13, a memory 14, an audio connector 15, sensors 16 and a connector 17 for connecting external sensors 18. Additionally, the mobile device 10 may comprise additional components, for example a display, a keypad, a loudspeaker and so on, but these components are not shown in FIG. 1 to simplify matters. The processing unit 13 is connected to the radio frequency transceiver 11, the microphone 12, the memory 14, the connectors 15, 17 and the sensors 16. The memory 14 may be used to store a plurality of audio files which may be played back by the processing unit 13 as audio data which may be output via the audio connector 15. The sensors 16 may comprise for example a camera for capturing image or video data, a gas sensor for sensing an ambient alcohol concentration, a carbon monoxide concentration or a carbon dioxide concentration, a smoke sensor and/or an acceleration sensor.

The mobile device 10 may be connected via a wired or a wireless connection, for example a Bluetooth connection, to a desk stand 60 comprising an audio amplifier for outputting audio data received from the mobile device 10 via loudspeakers 61 and 62.

Operation of the mobile device 10 will be now described in more detail in connection with FIGS. 1, 2 and 3.

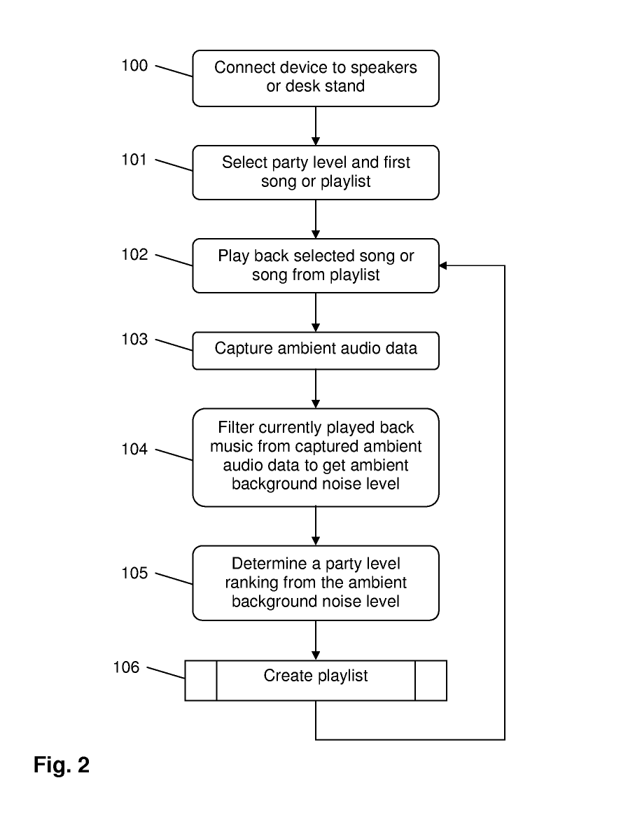

Assuming a user of the mobile device 10 wants to use the mobile device 10 for providing music at a party, the user may connect the mobile device 10 via the audio connector 15 with an audio equipment or a desk stand 60. The audio equipment or desk stand 60 is adapted to amplify audio data received from the mobile device 10 to a considerable volume and to play back the audio data via loudspeakers 61 and 62 to an audience of the party (step 100 in FIG. 2). Then, in step 101, the user may select a party level and a first song of a first playlist containing several songs to be played back. In step 102 the selected song or a song from the selected playlist is played back by the mobile device and the desk stand 60. While the music is being played back, in step 103 ambient audio data is captured by the mobile device 10, for example via microphone 12. In step 104 the processing unit 13 filters the currently played back music from the captured ambient audio data to get an ambient background noise level. In the next step 105 the processing unit determines a party level ranking from the ambient background noise level. Based on the party level ranking the processing unit 13 creates in step 106 a playlist containing songs to be played back after the currently played back song in step 102.

For creating the playlist in step 106, the processing unit may retrieve media files stored in memory 14 of the mobile device 10 or the processing unit may retrieve via the network 30 media files from an appropriate server 50 and transfer the retrieved audio data from the server 50 via the network 30 and provides the audio data at the audio connector 15 to the desk stand 60.

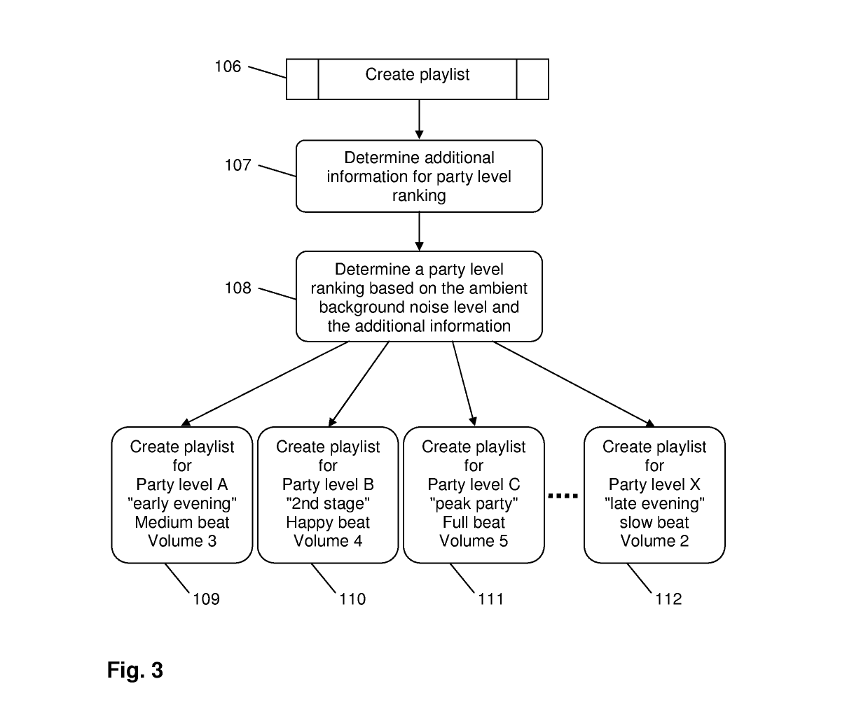

Creating the playlist (step 106 in FIG. 2) will be now described in more detail in connection with FIG. 3. Creating the playlist may be based on the determined ambient background noise level only or may be based additionally on further information provided by sensors 16 and/or external sensors 18 (step 107). The external sensors 18 may be connectable via a wired connection or a wireless connection. For example, one of the sensors 16, 18 may be a gas sensing sensor providing an information about an ambient alcohol concentration of the air surrounding the mobile device. Based on this, music for a playlist may be selected depending on how much alcohol is already consumed. Furthermore, one of the sensors 16, 18 may comprise a smoke sensor providing an information about the smoke concentration in an ambience of the mobile device 10. Additionally, a time of day information may be determined to select songs for the playlist. For example, in an early stage of the party the music shall not drown the talking of the people out and therefore the playlist should contain slower music with a lower beat rate. Once the party is going on, everybody starts raising the voice and the music needs to be more up tempo. Then, in last hours of the party, everybody is tired and the music needs to slow down. Therefore, in step 108 a party level ranking is determined based on the ambient background noise level and the additional information provided by the sensors 16, 18 and a time of day or a day of week information. Different party levels, for example A, B, C, . . . , X, may be defined to specify certain mood states of a party. Depending on the category or party level ranking, a corresponding playlist is created, as shown in steps 109-112 in FIG. 3. For example, each party level ranking or category may define a beat rate for a song of the playlist and a volume for reproducing the songs of the playlist. For example, a party level A may be defined to be used in an early evening state of the party. Songs of a playlist for party level A should therefore provide a medium beat rate and should be played back for example at volume 3. When the party is ongoing and everybody starts raising their voice, a party level B called for example “second stage” may be reached. Songs for a playlist for party level B should provide a higher beat rate than party level A, for example a so-called heavy beat rate, and the songs should be played back for example at volume 4. Next, when the party reaches its peak, party level C may be reached. Songs for a playlist of party level C should have a high beat rate, a so-called full beat, and should be played back for example at volume 5. Several more party levels may be defined. Finally, at the end of the party a party level X may be reached called “late evening” and songs of party level X should provide a slow beat rate and should be played back at a lower volume, for example at volume 2. The volume levels assigned to the party levels may indicate relative volume values for adjusting the volume level of audio data being played back relative to a starting point volume level.

While exemplary embodiments have been described above, various modification may be implemented in other embodiments. For example, the songs for a playlist may be selected taking into account a voice characteristic information in the ambient background noise. Depending on a determination if there are more deep voices or high voices, the processing unit 13 may select audio data which may be preferred by a male audience or a female audience.

Finally, it is to be understood that all the embodiments described above are considered to be comprised by the present invention as it is defined by the appended claims.

What is claimed is:

1. A method for selecting audio data to be played back in an audio reproduction device, comprising:
determining ambient information about an ambience of the audio reproduction device, and
automatically selecting audio data to be played back from a plurality of audio data depending on the determined ambient information.

2. The method according to claim 1, wherein the ambient information comprises an ambient background noise level of the ambience of the audio reproduction device.

3. The method according to claim 2, wherein determining the ambient background noise level comprises:
capturing ambient audio data of the ambience of the audio reproduction device, and
removing audio data currently played back by the audio reproduction device from the captured ambient audio data to determine the ambient background noise level.

4. The method according to claim 1, wherein the ambient information comprises an information selected from the group comprising:
a movement information about objects in an ambience of the audio reproduction device,
a movement information of a user carrying the audio reproduction device,
an ambient illumination information,
a weight sensor information,
a smoke sensor information,
a gas sensor information,
an information about an ambient alcohol concentration of the audio reproduction device,
a voice characteristic information in ambient background noise, and
a temperature sensor information.

5. The method according to claim 1, wherein automatically selecting audio data to be played back comprises:
providing a plurality of mood categories,
assigning each of the plurality of audio data to at least one of the plurality of mood categories,
assigning ambient information ranges of the ambient information to each of the plurality of mood categories,
selecting one of the mood categories based on the determined ambient information, and
selecting audio data assigned to the selected mood category as the audio data to be played back.

6. The method according to claim 5, wherein each of the plurality of audio data is assigned to at least one of the plurality of mood categories based on a speed of a beat of the audio data.

7. The method according to claim 5, wherein each mood category comprises a volume offset level to adjust the volume of the audio data of the mood category when being played back.

8. The method according to claim 5, further comprising:
capturing an input from a user specifying a mood category, and
playing back audio data assigned to the specified mood category.

9. The method according to claim 5, further comprising:
capturing a first input from a user specifying a mood category,
outputting audio data identifiers of the audio data assigned to the specified mood category to the user,
capturing a second input from the user selecting at least one of the audio data identifiers,
playing back the audio data identified by the selected audio data identifier.

10. The method according to claim 1, wherein the audio data comprises an audio file containing audible music when being played back.

11. The method according to claim 1, wherein the audio data comprises a list of audio files containing audible music when being played back.

12. The method according to claim 1, wherein the audio reproduction device comprises a device selected from the group comprising a stationary device, a mobile device, a mobile phone, a personal digital assistant, a mobile navigation system, a mobile music player and a mobile computer.

13. A method for selecting audio data to be played back in an audio reproduction device, comprising:
determining a time information, and
automatically selecting audio data to be played back from a plurality of audio data depending on the determined time information.

14. The method according to claim 13, wherein the time information comprises at least one of a time of day information and a day of the week information.

15. An audio reproduction device comprising a processing unit having access to a plurality of audio data, wherein the processing unit is adapted to:
determine an ambient information about an ambience of the audio reproduction device, and
automatically select audio data to be played back from the plurality of audio data depending on the determined ambient information.

16. The audio reproduction device according to claim 15, wherein the audio reproduction device comprises a device selected from the group comprising a mobile device, a stationary device, a mobile phone, a personal digital assistant, a mobile navigation system, a mobile music player and a mobile computer.

17. An audio reproduction device comprising a processing unit having access to a plurality of audio data, wherein the processing unit is adapted to:
determine a time information, and
automatically select audio data to be played back from the plurality of audio data depending on the determined time information.

18. The audio reproduction device according to claim 17, wherein the audio reproduction device comprises a device selected from the group comprising a mobile device, a stationary device, a mobile phone, a personal digital assistant, a mobile navigation system, a mobile music player and a mobile computer.
